(19) United States
(12) Patent Application Publication
(10) Pub. No.: US 2012/0100439 A1
(43) Pub. Date: Apr. 26, 2012

(54) ELECTROLYTE SOLUTION FOR SECONDARY LITHIUM BATTERY AND SECONDARY LITHIUM BATTERY INCLUDING THE ELECTROLYTE SOLUTION

(75) Inventors: Yoon-sok Kang, Seongnam-si (KR); Seok-soo Lee, Yongin-si (KR); Jae-gu Yoon, Suwon-si (KR); Jin-hwan Park, Seoul (KR); Mi-jeong Song, Suwon-si (KR)

(73) Assignee: Samsung Electronics Co., Ltd., Suwon-si (KR)

(21) Appl. No.: 13/117,521

(22) Filed: May 27, 2011

(30) Foreign Application Priority Data
Oct. 25, 2010 (KR) 10-2010-0104187

(51) Int. Cl. H01M 10/056

(52) U.S. Cl. 429/341; 429/188

(57) ABSTRACT

An electrolyte solution for a secondary lithium battery, the electrolyte solution including: a lithium salt, a non-aqueous organic solvent, and a phenanthroline-based compound having a polar substituent. The electrolyte solution enables production of a secondary lithium battery having good high-temperature lifetime characteristics and good high-temperature preservation characteristics.

### CROSS-REFERENCE TO RELATED APPLICATIONS

This application claims the benefit of Korean Application No. 10-2010-0104187, filed on Oct. 25, 2010 in the Korean Intellectual Property Office, the disclosure of which is incorporated herein by reference.

### BACKGROUND

1. Field

Aspects of the present disclosure relate to electrolyte solutions for secondary lithium batteries and secondary lithium batteries including the electrolyte solutions. More particularly, aspects of the present disclosure relate to electrolyte solutions that are used in secondary lithium batteries and improve high-temperature lifetime characteristics and high-temperature preservation characteristics of the secondary lithium batteries as well as secondary lithium batteries including the electrolyte solutions.

2. Description of the Related Art

Secondary lithium batteries have been used as power sources for various portable devices due to their high energy densities and ease of manufacturing. Recently, besides portable IT devices, secondary lithium batteries are further used as power sources for electric vehicles and for electric power storage. The widened application range of secondary lithium batteries has led to much research into materials with high-energy densities and long lifespan. From among such materials, an additive that does not affect properties of an electrolyte and improves performance of a secondary lithium battery when used in a small amount in an electrolyte solution is getting much attention.

Electrolyte solution additives have various functions. For example, an electrolyte solution additive forms a solid electrolyte interface (SEI) for preventing direct contact between an electrode active material and an electrolyte. Such an electrolyte solution additive may be categorized as an additive for an anode that aids formation of an SEI on the surface of graphite and as an over charge protection (OCP) additive for a cathode that forms a thick film on the surface of a cathode.

Although research into high-voltage cathode active materials is being performed in reaction to an increasing demand for secondary lithium batteries with high energy densities, for example, batteries for electric vehicles, there is not enough research into an electrolyte solution additive that prevents oxidation of an electrolyte occurring at the surface of a cathode active material.

In general, the potential window of an electrolyte needs to be wider than the potential difference between a cathode active material and an anode active material. However, the increasing use of high-voltage active materials to increase energy density of a battery results in a narrower potential window of the electrolyte than the potential difference of the active materials. Accordingly, decomposition of an electrolyte needs to be prevented, for example by forming a film for preventing direct contact between an electrolyte and an electrode active material.

When a typical aromatic compound, such as biphenyl or terphenyl, is used as an electrolyte solution additive, the electrolyte solution additive acts as an over-charge preventing element. That is, when the voltage of a battery is increased to a certain level or greater, the electrolyte solution additive may form a thick film on the surface of a cathode to prevent lithium ions from flowing therethrough. According to a recently published report, a thin film is formed at the surface of a cathode by using a low concentration of such an additive and the thin film improves lifetime characteristics of a battery (Electrochemical and Solid-State Letters, 7(12) A462-A465 (2004)). However, the thin film is non-polar and thus it is difficult for lithium ions to pass therethrough, thereby degrading battery characteristics.

Meanwhile, since batteries for electric vehicles and for electric power storage are exposed out of doors and are likely to be heated due to instantaneous charging/discharging, they need to be appropriately driven at high temperatures.

### SUMMARY

Electrolyte solutions for a secondary lithium battery are provided, in which the electrolyte solutions prevent oxidation of an electrolyte at the surface of a cathode and release of metal ions from a cathode active material at high temperatures.

Secondary lithium batteries are also provided, which have excellent high-temperature lifetime characteristics and excellent high-temperature preservation characteristics.

According to an aspect of the present invention, an electrolyte solution for a secondary lithium battery includes a lithium salt, a non-aqueous organic solvent, and an additive, wherein the additive includes a phenanthroline-based compound including at least one polar substituent selected from the group consisting of an alkoxy group, an amine group, an ester group, a carbonate group, a carbonyl group, a keto group, an epoxy group, and an alkylthio group.

The phenanthroline-based compound may include 1,10-phenanthroline, 1,7-phenanthroline, or 4,7-phenanthroline.

The additive may include 4,7-dimethoxy-1,10-phenanthroline, 1,10-phenanthroline-5,6-dione, or 5,6-epoxy-5,6-dihydro-1,10-phenanthroline.

According to another aspect of the present invention, a secondary lithium battery includes a cathode; an anode; and the electrolyte solution described above.

According to another aspect of the present invention, a secondary lithium battery includes a cathode; an anode; and an electrolyte solution, wherein the electrolyte solution is the electrolyte solution described above, the cathode has a surface on which a thin film is formed, and the thin film is derived from either a part of the additive or the entire additive.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a conceptual view for explaining the process of forming a thin film from an electrolyte solution for a secondary lithium battery on the surface of a cathode, according to an embodiment of the present invention;

FIG. 2 is an exploded perspective view of a secondary lithium battery according to an embodiment of the present invention;

FIG. 3 is a graph showing room-temperature lifetime characteristics of secondary lithium batteries manufactured according to Examples 4-6 and Comparative Examples 3 and 4;

FIG. 4 is a graph showing high-temperature lifetime characteristics of secondary lithium batteries manufactured according to Examples 4-6 and Comparative Examples 3 and 4;

FIG. 5 is a graph of an open circuit voltage (OCV) drop of secondary lithium batteries manufactured according to Examples 4 and 5 and Comparative Examples 3 and 4 after they were exposed to a high temperature; and

FIG. 6 is a graph of a capacity retention rate of secondary lithium batteries manufactured according to Examples 4 and 5 and Comparative Examples 3 and 4 after they were exposed to a high temperature.

### DETAILED DESCRIPTION

Reference will now be made in detail to the present embodiments of the present invention, examples of which are illustrated in the accompanying drawings, wherein like reference numerals refer to like elements throughout. The embodiments are described below in order to explain the present invention by referring to the figures.

An electrolyte solution for a secondary lithium battery according to an embodiment of the present invention includes a lithium salt, a non-aqueous organic solvent, and an additive, in which the additive is a phenanthroline-based compound including at least one polar substituent selected from the group consisting of an alkoxy group, an amine group, an ester group, a carbonate group, a carbonyl group, a keto group, an epoxy group, and an alkylthio group. The amount of the additive contained in the electrolyte solution may be in a range of about 0.001 to about 5 weight %.

The polar substituent-containing phenanthroline-based compound is easily oxidized, due to the three conjugated aromatic rings, during initial charging to form a thin film on the surface of a cathode, thereby preventing oxidation of an electrolyte at the surface of the cathode. In addition, since the phenanthroline-based compound has nitrogen atoms in the hetero aromatic rings and the polar substituent, the phenanthroline-based compound provides a channel through which lithium ions of the electrolyte smoothly flow, thereby enabling production of a battery having good charging and discharging characteristics, for example, good cyclic characteristics.

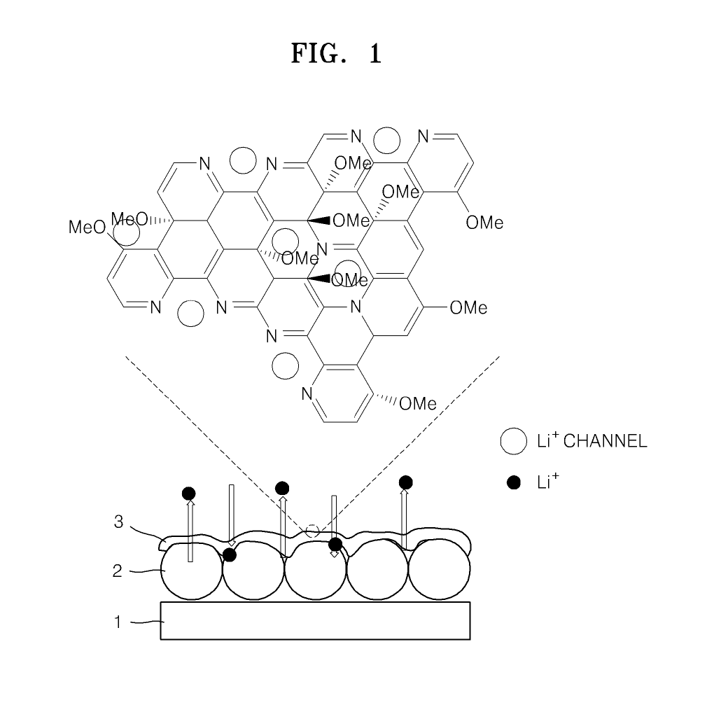

FIG. 1 is a conceptual view for explaining the process of forming a thin film from an electrolyte solution for a secondary lithium battery on the surface of a cathode according to an embodiment of the present invention. Referring to FIG. 1, a phenanthroline-based compound including a polar substituent, for example, a methoxy group, decomposes during initial charging to form a polymer, thereby forming a Li⁺-conducting thin film 3 on a cathode active material 2 that is disposed on a surface of a cathode substrate 1. That is, the decomposition potential of the phenanthroline-based compound having three conjugated aromatic rings is lower than the decomposition potential of an electrolyte and, thus the phenanthroline-based compound is oxidized to form a thin film before the electrolyte is oxidized at the surface of a cathode. In addition, the nitrogen atoms in the hetero aromatic rings and the polar substituent form a channel through which lithium ions flow, thereby allowing lithium ions to smoothly flow in the electrolyte.

In the polar substituent-containing phenanthroline-based compound, the alkoxy group may include one to twelve carbon atoms. The alkoxy group may be, for example, methoxy. The phenanthroline-based compound may include one or more polar substituents, and when the number of the polar substituents is two or more, the polar substituents may be identical to or different from each other. When the polar substituent is an epoxy group, an oxygen atom forms an epoxy with adjacent carbon atoms of the conjugated hetero aromatic ring of the phenanthroline-based compound.

The polar substituent-containing phenanthroline-based compound may be 1,10-phenanthroline, 1,7-phenanthroline, or 4,7-phenanthroline.

Examples of the polar substituent-containing phenanthroline-based compound are 4,7-dimethoxy-1,10-phenanthroline, 1,10-phenanthroline-5,6-dione, or 5,6-epoxy-5,6-dihydro-1,10-phenanthroline.

The non-aqueous organic solvent included in the electrolyte solution may act as a medium through which ions participating in an electrochemical reaction of a battery flow, and may be any one of various solvents that are typically used in the art. Examples of the non-aqueous organic solvent are a carbonate-based solvent, an ester-based solvent, an ether-based solvent, a ketone-based solvent, an alcohol-based solvent, a non-protonic solvent, or a combination thereof. Examples of a carbonate-based solvent are dimethyl carbonate (DMC), diethyl carbonate (DEC), dipropyl carbonate (DPC), methyl propyl carbonate (MPC), ethylpropyl carbonate (EPC), ethyl methyl carbonate (methylethyl carbonate, EMC or MEC), ethylene carbonate (EC), propylene carbonate (PC), and butylene carbonate (BC), and examples of the ester-based solvent are methyl acetate, ethyl acetate, n-propyl acetate, dimethyl acetate, methyl propionate, ethyl propionate, γ-butyrolactone, 5-decanolide, γ-valerolactone, dl-mevalonolactone, and γ-caprolactone. Examples of an ether-based solvent are di-n-butyl ether, tetraglyme, diglyme, 1,2-dimethoxy ethane, 2-methyltetrahydrofuran, and tetrahydrofuran, and examples of a ketone-based solvent are cyclohexanone, etc. Examples of an alcohol-based solvent are ethyl alcohol and isopropyl alcohol, and examples of a non-protonic solvent are nitriles represented by R—CN (where R is a linear, branched, or cyclic C2-C20 hydrocarbonyl, and may have a double-bond aromatic ring or an ether bond), amides such as dimethylformamide, dioxolanes such as 1,3-dioxolane, and sulfolane.

The non-aqueous organic solvents may be used alone or in combination. If the non-aqueous organic solvents are used in combination, a mixed ratio may be appropriately controlled according to the required battery performance as is known in the art.

Also, when the non-aqueous organic solvent includes a carbonate-based solvent, the carbonate-based solvent may include a cyclic carbonate and a chain carbonate. In this case, the volumetric ratio of the cyclic carbonate to the chain carbonate may be in the range of about 1:1 through about 1:9 so as to prepare an electrolyte solution having excellent performance.

The non-aqueous organic solvent may further include, in addition to the carbonate-based solvent, an aromatic hydrocarbon-based organic solvent. In this regard, the volumetric ratio of the carbonate-based solvent and the aromatic hydrocarbon-based organic solvent may be in the range of about 1:1 through about 30:1.

The aromatic hydrocarbon-based organic solvent may be an aromatic hydrocarbon-based compound represented by Formula 1 below:

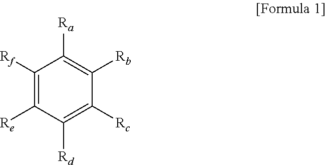

in which Rₐ through R_{f} may each independently be a hydrogen atom, a halogen, a C1-C10 alkyl group, a haloalkyl group, or a combination thereof.

Examples of the aromatic hydrocarbon-based organic solvent are benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, 2-fluorotoluene, 3-fluorotoluene, 4-fluorotoluene, 2,3-difluorotoluene, 2,4-difluorotoluene, 2,5-difluorotoluene, 2,3,4-trifluorotoluene, 2,3,5-trifluorotoluene, 2-chlorotoluene, 3-chlorotoluene, 4-chlorotoluene, 2,3-dichlorotoluene, 2,4-dichlorotoluene, 2,5-dichlorotoluene, 2,3,4-trichlorotoluene, 2,3,5-trichlorotoluene, 2-iodotoluene, 3-iodotoluene, 4-iodotoluene, 2,3-diiodotoluene, 2,4-diiodotoluene, 2,5-diiodotoluene, 2,3,4-triiodotoluene, 2,3,5-triiodotoluene, o-xylene, m-xylene, p-xylene, and combinations thereof.

The lithium salt included in the electrolyte solution is dissolved in an organic solvent and acts as a suppler of lithium ions in a secondary lithium battery to enable driving of the secondary lithium battery, and promotes flow of lithium ions between a cathode and an anode. The lithium salt may be any one of various materials that are typically used in lithium batteries. Examples of the lithium salt are LiPF₆, LiBF₄, LiSbF₆, LiAsF₆, LiCF₃SO₃, LiN(CF₃SO₂)₃, Li(CF₃SO₂)₂N, LiC₄F₉SO₃, LiClO₄, LiAlO₂, LiAlCl₄, LiN(CₓF₂ₓ₊₁SO₂)(CₓF_{2y+1}SO₂) where x and y are natural numbers, LiCl, LiI, lithium bis(oxalate)borate, and a combination thereof. The lithium salts may also be used as a supporting electrolytic salt.

The concentration level of the lithium salt may be at the same level as used in the art and is not particularly limited herein. For example, the concentration of the lithium salt may be in the range of about 0.1 to about 2.0 M in the electrolyte solution. If the concentration of the lithium salt is within that concentration range, the concentration of the electrolyte may be appropriately maintained to improve performance of an electrolyte and the viscosity of the electrolyte solution may be appropriately maintained to improve mobility of lithium ions.

Hereinafter, a secondary lithium battery including an electrolyte solution according to an embodiment of the present invention will be described in detail. A secondary lithium battery according to an embodiment of the present invention includes a cathode, an anode, and an electrolyte solution, in which the electrolyte solution includes a lithium salt, a non-aqueous organic solvent, and an additive, in which the additive is a phenanthroline-based compound including a polar substituent.

A secondary lithium battery according to another embodiment of the present invention includes a cathode, an anode, and an electrolyte solution, in which the electrolyte solution includes a lithium salt, a non-aqueous organic solvent, and an additive, in which the additive is a phenanthroline-based compound including a polar substituent, in which the cathode has a surface on which a thin film is formed and the thin film is derived from either a part of the additive or the entire additive.

In the secondary lithium battery according to these embodiments, a part of the additive included in the electrolyte solution may decompose or the entire additive may decompose, thereby forming a thin film on the surface of the cathode. Accordingly, even when the secondary lithium battery is charged at a relatively high voltage, direct contact of an electrolyte with a cathode active material does not occur and thus, the lifetime of the secondary lithium battery is increased. Also, the secondary lithium batteries have good lifetime characteristics and good capacity retention characteristics even at high temperatures.

Regarding the secondary lithium batteries according to the embodiments of the present invention, the thin film formed on the surface of the cathode may have a thickness of about 1 nm to about 80 nm. If the thickness of the thin film is within the range described above, the thin film may not adversely affect transportation of lithium ions and may effectively prevent oxidation of an electrolyte at the surface of the cathode. Also, the phenanthroline-based compound including the polar substituent has a lower polymerization potential due to an electron donation effect of the polar substituent, for example, methoxy, and thus, polymerization may occur faster, thereby forming a higher density of the thin film. Such a thin film may further lower the possibility of the direct contact of the cathode active material and the electrolyte, thereby contributing to an increase in room-temperature and high-temperature lifetime of the battery. Although the higher density of a thin film leads to more difficult passage of lithium ions, the thin film used in the present embodiment enables lithium ions to easily pass therethrough due to the polar substituent and its chelatable nitrogen atom.

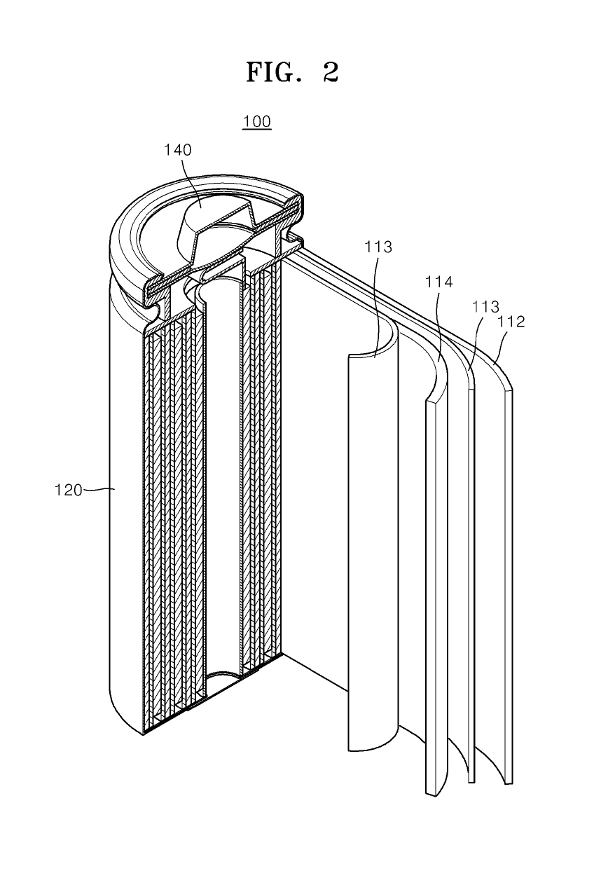

FIG. 2 is an exploded perspective view of a secondary lithium battery according to an embodiment of the present invention. The secondary lithium battery of FIG. 2 is cylindrical, but the shape of the secondary lithium battery is not limited thereto. For example, the secondary lithium battery according to the present embodiment may instead be rectangular or pouch-shaped.

Secondary lithium batteries are categorized into lithium ion batteries, lithium ion polymer batteries, and lithium polymer batteries, according to the kinds of a separator used and the kinds of an electrolyte used; into cylindrical batteries, rectangular batteries, coin-type batteries, or pouch-type batteries, according to the shape of the secondary lithium battery; and into bulk-type batteries and thin-type batteries, according to size. The shape of a secondary lithium battery according to these embodiments of the present invention is not particularly limited. Since structures of the batteries and methods of manufacturing the batteries are known in the art, they will not be described in detail herein.

Referring to FIG. 2, the secondary lithium battery 100 is cylindrical, and basically includes an anode 112, a cathode 114, a separator 113 interposed between the anode 112 and the cathode 114, an electrolyte solution (not shown) with which the anode 112, the cathode 114, and the separator 113 are impregnated, a battery container 120, and a sealing member 140 for sealing the battery container 120. In order to manufacture the secondary lithium battery 100, the anode 112, the cathode 114, and the separator 113 are sequentially stacked on each other and then rolled in a jelly roll form and placed in the battery container 120.

The anode 112 includes a current collector and an anode active material layer formed on the current collector, in which the anode active material layer includes an anode active material. The anode active material may be any one of various materials that are used in the art. Examples of the anode active material are lithium metal, a metal material that is alloyable with lithium, transition metal oxide, a material that is capable of doping or undoping lithium, and a material that enables reversible intercalation and deintercalation of lithium ions.

Examples of a transition metal oxide are vanadium oxide and lithium vanadium oxide. Examples of a material that is capable of doping or undoping lithium are silicon (Si); SiOₓ (0<x<2); Si-T alloy where T is an alkali metal, an alkali earth metal, a Group 13 element, a Group 14 element, a transition metal, a rare-earth element, or a combination thereof and is not Si; Sn; SnO₂; and Sn—R where R is an alkali metal, an alkali earth metal, a Group 13 element, a Group 14 element, a transition metal, a rare-earth element or a combination thereof element and is not Sn, in which at least one of these materials may be used in combination of SiO₂. Examples of the elements T and R are magnesium (Mg), calcium (Ca), strontium (Sr), barium (Ba), scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), rhenium (Re), iron (Fe), lead (Pb), ruthenium (Ru), osmium (Os), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), and a combination thereof.

A material that enables reversible intercalation and deintercalation of lithium ions may be any one of various carbonaceous anode active materials that are typically used in a secondary lithium ion battery. Examples of materials that enable reversible intercalation and deintercalation of lithium ions are crystalline carbon, amorphous carbon, or a mixture thereof. Examples of a crystalline carbon are a natural graphite and an artificial graphite, each of which is shapeless, plate-shaped, flake-shaped, spherical, or fibrous, and examples of an amorphous carbon are soft carbon (low-temperature calcined carbon), hard carbon, mesophase pitch carbon, and calcined coke.

The anode active material layer may further include a binder, and may selectively include a conductive agent.

The binder may allow anode active material particles to be attached to each other and may also allow the anode active material to be attached to the current collector. Examples of the binder are polyvinylalcohol, carboxymethylcellulose, hydroxypropyl cellulose, diacetyl cellulose, polyvinylchloride, carboxylated polyvinylchloride, polyvinyl fluoride, polyethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, and nylon. However, the binder is not limited thereto.

The conductive agent may be any one of various materials that provide conductivity to an electrode, do not cause a chemical change in a battery including the conductive agent, and conduct electrons. Examples of the conductive agent are natural graphite, artificial graphite, carbon black, acetylene black, ketjen black, carbon fiber, and powder or fiber of a metal such as copper, nickel, aluminum, or silver. In addition, the conductive agent may include one or more polyphenylene derivatives.

Examples of the current collector may be a copper film, a nickel film, a stainless steel film, a titanium film, a nickel foam, a copper foam, a polymer substrate coated with a conductive metal, or a combination thereof. The cathode 114 may include a current collector, and a cathode active material layer formed on the current collector.

The cathode active material may be any one of various materials that are typically used in the art and are not particularly limited. For example, the cathode active material may be a compound to which lithium ions are intercalated or from which lithium ions are deintercalated. The cathode active material may include one or more oxides of lithium and metal selected from the group consisting of cobalt, manganese, nickel, and a combination thereof. Examples of the cathode active material are compounds represented by LiₐA_{1-b}B_{b}D₂ where 0.90≦a≦1.8, and 0≦b≦0.5; LiₐE_{1-b}B_{b}O_{2-c}D_{c} where 0.90≦a≦1.8, 0≦b≦0.5, and 0≦c≦0.05; LiE_{2-b}B_{b}O_{4-c}D_{c} where 0≦b≦0.5 and 0≦c≦0.05; LiₐNi_{1-b-c}CO_{b}B_{c}D_{α} where 0.90≦a≦1.8, 0≦b≦0.5, 0≦c≦0.05, and 0≦α≦2; LiₐNi_{1-b-c}CO_{b}B_{c}O_{2-α}F_{α} where 0.90≦a≦1.8, 0≦b≦0.5, 0≦c≦0.05, and 0<α<2; LiₐNi_{1-b-c}CO_{b}B_{c}O_{2-α}F₂ where 0.90≦a≦1.8, 0≦b≦0.5, 0≦c≦0.05, and 0<α<2; LiₐNi_{1-b-c}Mn_{b}B_{c}D_{α} where 0.90≦a≦1.8, 0≦b≦0.5, 0≦c≦0.05, and 0<α≦2; LiₐNi_{1-b-c}Mn_{b}B_{c}O_{2-α}Fₐ where 0.90≦a≦1.8, 0≦b≦0.5, 0≦c≦0.05, and 0<α<2; LiₐNi_{1-b-c}Mn_{b}B_{c}O_{2-α}F₂ where 0.90≦a≦1.8, 0≦b≦0.5, 0≦c≦0.05, and 0<α<2; LiₐNi_{b}E_{c}G_{d}O₂ where 0.90≦a≦1.8, 0≦b≦0.9, 0≦c≦0.5, and 0.001≦d≦0.1; LiₐNi_{b}CO_{c}Mn_{d}GeO₂ where 0.90≦a≦1.8, 0≦b≦0.9, 0≦c≦0.5, 0≦d≦0.5, and 0.001≦e≦0.1; LiₐNiG_{b}O₂ where 0.90≦a≦1.8, and 0.001≦b≦0.1; LiₐCoG_{b}O₂ where 0.90≦a≦1.8, and 0.001≦b≦0.1; LiₐMnG_{b}O₂ where 0.90≦a≦1.8, and 0.001≦b≦0.1; LiₐMn₂G_{b}O₄ where 0.90≦a≦1.8, and 0.001≦b≦0.1; QO₂; QS₂; LiQS₂; V₂O₅; LiV₂O₅; LiIO₂; LiNiVO₄; Li_{(3-f)}J₂(PO₄)₃ where 0≦f≦2; Li_{(3-f)}Fe₂(PO₄)₃ where 0≦f≦2; and LiFePO₄.

In the formulae above, A is Ni, Co, Mn, or a combination thereof; B is Al, Ni, Co, Mn, Cr, Fe, Mg, Sr, V, a rare-earth element or a combination thereof; D is O, F, S, P, or a combination thereof; E is Co, Mn, or a combination thereof; F is fluorine (F), sulfur (S), phosphorus (P), or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof.

The cathode active materials may have surfaces on which a coating layer is formed. Alternatively, the cathode active materials may be used in combination with a compound having a coating layer. The coating layer may include a coating element compound, such as an oxide or hydroxide of a coating element, an oxyhydroxide of a coating element, an oxycarbonate of a coating element, or a hydroxy carbonate of a coating element. The coating layer may be formed of an amorphous or crystalline compound. A coating element included in the coating layer may be Mg, Al, Co, K, Na, Ca, Si, Ti, V, Sn, Ge, Ga, B, As, Zr, or a combination thereof. A process of forming the coating layer may be any coating method that is performed using the elements on the cathode active compounds and does not adversely affect properties of the cathode active materials (for example, spray coating or impregnation). The coating method may be obvious to one of ordinary skill in the art and thus will not be described in detail herein.

The cathode active material layer may include a binder and a conductive agent. The binder may allow cathode active material particles to be attached to each other and may also allow the cathode active material to be attached to the current collector. Examples of the binder are polyvinylalcohol, carboxymethylcellulose, hydroxypropyl cellulose, diacetyl cellulose, polyvinylchloride, carboxylated polyvinylchloride, polyvinylfluoride, polyethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, and nylon, but are not limited thereto.

The conductive agent may be any one of various materials that provide conductivity to an electrode, do not cause a chemical change in a battery including the conductive agent, and conduct electrons. Examples of the conductive agent are natural graphite, artificial graphite, carbon black, acetylene black, ketjen black, carbon fiber, and powder or fiber of metal such as copper, nickel, aluminum, or silver. In addition, the conductive agent may include one or more polyphenylene derivatives.

The current collector may be formed of aluminum (Al), but a material for forming the current collector is not limited thereto. In order to form the anode 112 and the cathode 114, a corresponding active material, a conductive agent, and a binder are mixed in a solvent to prepare an active material composition and the active material composition is coated on a current collector. This electrode manufacturing process is known in the art and thus, will not be described in detail herein. The solvent may be N-methylpyrrolidone, but is not limited thereto.

According to the kind of a secondary lithium battery, a separator may be present between a cathode and an anode. The separator may be formed of polyethylene, polypropylene, polyvinylidene fluoride, or may have a two or more-layered structure thereof. Also, the separator may be a mixed multilayer, such as a two-layered polyethylene/polypropylene separator, a three-layered polyethylene/polypropylene/polyethylene separator, or a three-layered polypropylene/polyethylene/polypropylene separator.

One or more embodiments will now be described in further detail with reference to the following examples. These examples are for illustrative purpose only and are not intended to limit the scope of any of the embodiments. In addition, some examples that are known to one of ordinary skill in the art may not be described in the following examples.

### Example 1

### Preparation of Electrolyte Solution for Secondary Lithium Battery

0.05 weight % of 4,7-dimethoxy-1,10-phenanthroline as an additive was added to a mixed organic solvent including 30 volume % of ethylene carbonate, 50 volume % of diethyl carbonate, and 20 volume % of ethyl methyl carbonate, and 1.3 M LiPF₆ was added thereto as a lithium salt to prepare an electrolyte solution for a secondary lithium battery.

### Example 2

### Preparation of Electrolyte Solution for Secondary Lithium Battery

An electrolyte solution for a secondary lithium battery was prepared in the same manner as in Example 1, except that 0.05 weight % of 1,10-phenanthroline-5,6-dione was used as an additive instead of 4,7-dimethoxy-1,10-phenanthroline.

### Example 3

### Preparation of Electrolyte Solution for Secondary Lithium Battery

An electrolyte solution for a secondary lithium battery was prepared in the same manner as in Example 1, except that 0.05 weight % of 5,6-epoxy-5,6-dihydroxy-1,10-phenanthroline was used as an additive instead of 4,7-dimethoxy-1,10-phenanthroline.

### Comparative Example 1

### Preparation of Electrolyte Solution for Secondary Lithium Battery

1.3 M LiPF₆ as a lithium salt was added to a mixed organic solvent including 30 volume % of ethylene carbonate, 50 volume % of diethyl carbonate, and 20 volume % of ethyl methyl carbonate to prepare an electrolyte solution for a secondary lithium battery. In this example, an additive was not used.

### Comparative Example 2

### Preparation of Electrolyte Solution for Secondary Lithium Battery

An electrolyte solution for a secondary lithium battery was prepared in the same manner as in Example 1, except that 0.05 weight % of 1,10-phenanthroline was used as an additive instead of 4,7-dimethoxy-1,10-phenanthroline.

### Example 4

### Manufacturing of Secondary Lithium Battery

Li₁₊ₓ(Mn,Ni,Co)₁₋ₓO₂(0.05≦x≦0.2) powder as a cathode active material, a binder prepared by dissolving 5 weight % of polyvinylidenefluoride (PVdF) in N-methylpyrrolidone (NMP), and a conductive agent (Denka black) were added to an agate mortar in a weight ratio of 92:4:4 and mixed to prepare a slurry. The slurry was bar-coated on a 15 μm-thick aluminum foil. The resultant product was placed in an oven at a temperature of 90° C. and dried for about 2 hours to evaporate the NMP. Then, the product was placed in a vacuum oven at a temperature of 120° C. and dried for about 2 hours to completely evaporate the NMP. Then, the product was pressed and punched to obtain a cathode having a thickness of 60 μm. The cathode had a capacity of about 1.7 mAh/cm² and a thickness of about 50 to about 60 μm.

A coin-type cell was manufactured using the cathode having a diameter of 1.5 cm, a graphite anode active material having a diameter of 1.6 cm, a polyethylene separator, and the electrolyte solution prepared according to Example 1.

### Examples 5 and 6

### Manufacturing of Secondary Lithium Batteries

Coin-type cells were manufactured in the same manner as in Example 4, except that the electrolyte solutions prepared according to Examples 2 and 3 were respectively used as an electrolyte solution.

### Comparative Example 3 and 4

### Manufacturing of Secondary Lithium Battery

Coin-type cells were manufactured in the same manner as in Example 4, except that the electrolyte solutions prepared according to Comparative Examples 1 and 2 were respectively used as an electrolyte solution.

### Experimental Example 1

### Charge and Discharge Test of Secondary Lithium Battery

A formation charge and discharge was performed twice on the coin-type cells manufactured according to Examples 4 through 6 and Comparative Examples 3 and 4. In the first formation phase, the coin-type cells were charged with an electric charge of 0.05 C until the voltage reached 4.53 V. Then, the coin-type cells were discharged with an electric charge of 0.05 C at a constant current until the voltage reached 2.5 V. In the second formation phase, the coin-type cells were charged with an electric charge of 0.1 C at a constant current until the voltage reached 4.5 V and then charged at a constant voltage of 4.5 V until the electric charge amount reached 0.05 C. Then, the coin-type cells were discharged with an electric charge of 0.1 C at a constant current until the voltage reached 2.5 V.

The coin-type cells that experienced the formation charge and discharge were charged with an electric charge of 0.5 C and then discharged with an electric charge of 0.2 C until the voltage reached 2.5 V. These charge and discharge conditions were set as reference charge and discharge conditions, and discharge capacity in this case was set as a reference capacity.

Then, the coin-type cells were charged with the current of 1 C and then discharged with the current of 1 C until the voltage reached 2.5 V. A discharge capacity in this case (discharge capacity in the fourth cycle) was measured. Such charge and discharge processes were repeatedly performed to evaluate cyclic lifetime characteristics of the coin-type cells. Discharge capacities of the coin-type cells in each cycle were measured and from the results, the respective cycle capacity retention rates were measured. The cycle capacity retention rates (%, cycle retention) were measured using Equation 1:

Cycle capacity retention rate(%)=Discharge capacity in n^{th} cycle/discharge capacity in fourth cycle [Equation 1]

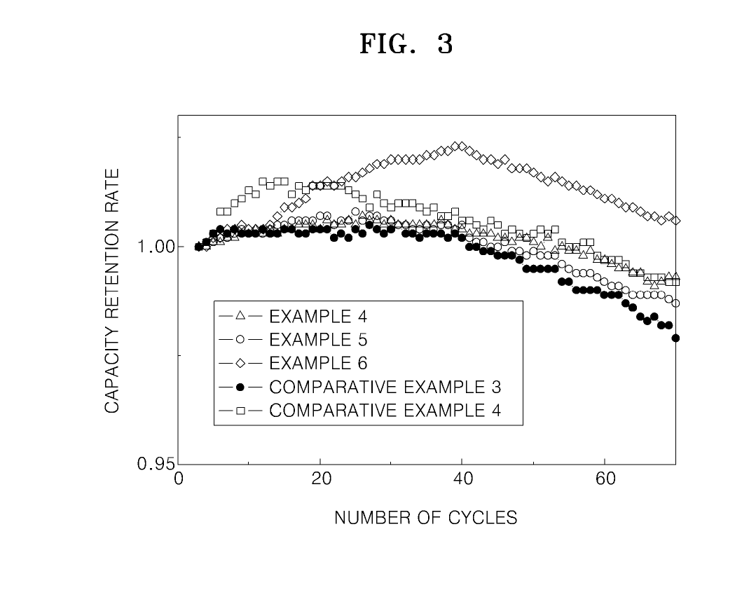

The cycle capacity retention rates are shown in Table 1 below and in FIG. 3.

TABLE 1

| | | | | Compar- | Compar- |
|---|---|---|---|---|---|
| | Exam- | Exam- | Exam- | ative | ative |
| | ple 4 | ple 5 | ple 6 | Example 3 | Example 4 |
| Discharge capacity | 2.58 | 2.49 | 2.40 | 2.42 | 2.49 |
| in 4th cycle (mAh) | | | | | |
| Discharge capacity | 2.56 | 2.45 | 2.41 | 2.40 | 2.43 |
| in 70th cycle (mAh) | | | | | |
| Cycle capacity | 99.2 | 98.6 | 100.4 | 99.0 | 97.8 |
| retention rate (%) | | | | | |

Referring to Table 1 and FIG. 3, it was confirmed that the coin-type cells of Examples 4 through 6 have better room-temperature lifetime characteristics than the coin-type cells of Comparative Examples 3 and 4.

Also, in order to identify high-temperature lifetime characteristics of a secondary lithium battery according to an embodiment of the present invention, the lifetime characteristics test was performed in the same manner as described above, except that the cycle lifetime evaluation (1 C charging/1 C discharging) was performed in a chamber at a high temperature of 60° C.

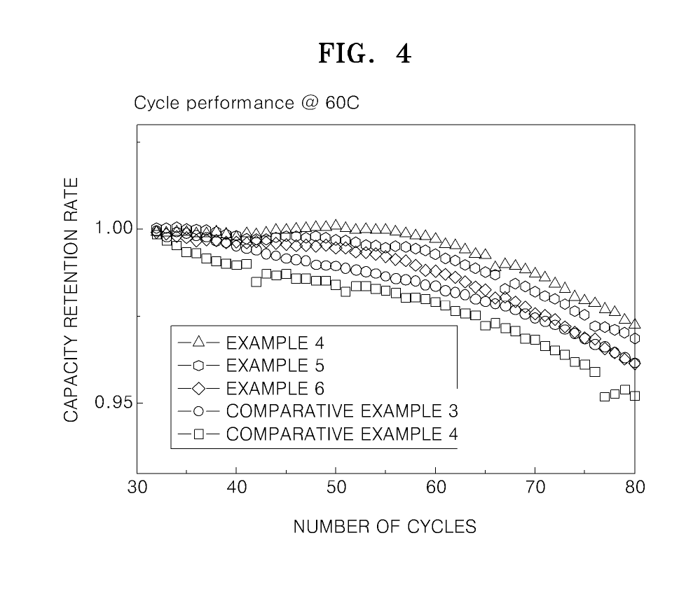

The cycle capacity retention rates are shown in Table 2 below and FIG. 4.

TABLE 2

| | | | | Compar- | Compar- |
|---|---|---|---|---|---|
| | Exam- | Exam- | Exam- | ative | ative |
| | ple 4 | ple 5 | ple 6 | Example 3 | Example 4 |
| Discharge capacity | 2.69 | 2.65 | 2.5 | 2.53 | 2.84 |
| in 4th cycle (mAh) | | | | | |
| Discharge capacity | 2.52 | 2.47 | 2.69 | 2.32 | 2.63 |
| in 70th cycle (mAh) | | | | | |
| Cycle capacity | 93.7 | 93.4 | 92.3 | 91.8 | 92.8 |
| retention rate (%) | | | | | |

Referring to Table 2 and FIG. 4, the coin-type cells of Examples 4 through 6 have higher cycle capacity retention rates than the coin-type cells of Comparative Example 3 and 4 in the 70^{th} cycle with respect to the initial capacity. In particular, regarding the coin cell of Comparative Example 4, which was manufactured without an additive, a capacity decrease began in about the 30^{th} cycle, and regarding the coin-type cells of Examples 7 and 8, relatively high capacity was maintained even in the 70^{th} cycle.

Also, coin-type cells that experienced the formation charge and discharge twice and the reference charge and discharge once were charged under the reference charge and discharge conditions and left at a temperature of 90° C. for about 4 hours and discharge capacities (discharge capacity after leaving them at a high temperature) thereof were measured and high-temperature capacity retention rates were calculated from the measurement results. Also, open circuit voltages (OCV) before and after leaving the coin-type cells at the high temperature were measured.

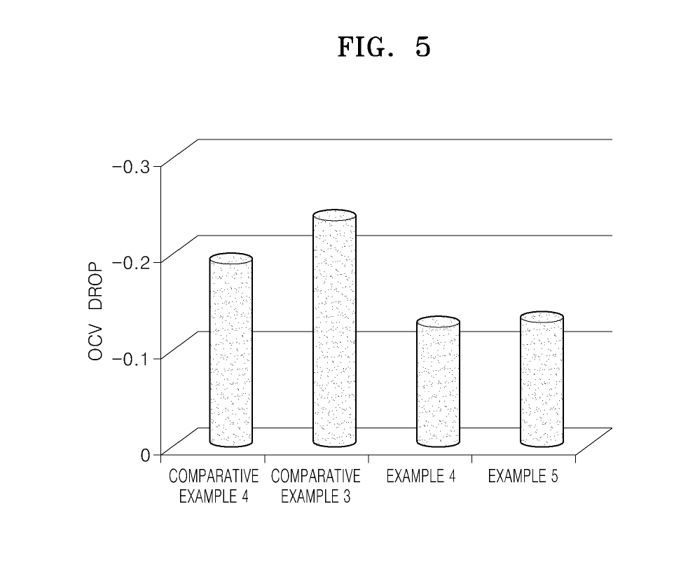

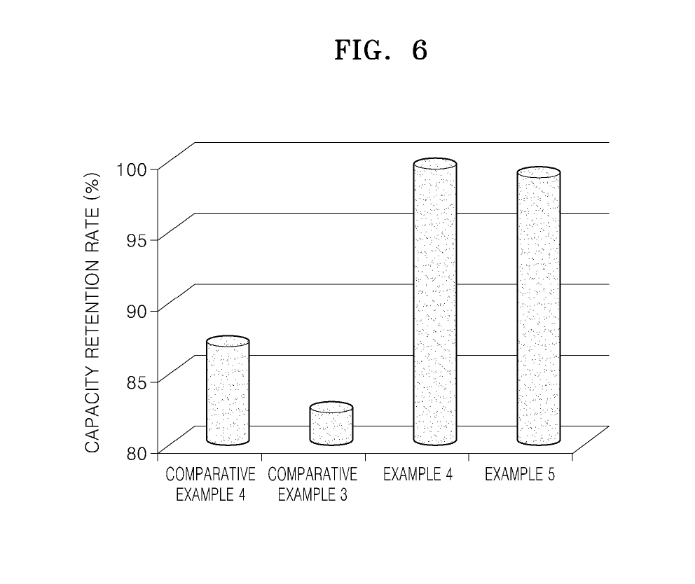

The high-temperature capacity retention rates, and OCVs before and after leaving the coin-type cells at the high temperature and differences therebetween are shown in Table 3 and FIGS. 5 and 6. The high-temperature capacity retention rates (%, retention) are obtained using Equation 2 below.

High-temperature capacity retention rate(%)=discharge capacity after leaving at high temperature/reference capacity [Equation 2]

TABLE 3

| | Exam- | Exam- | Comparative | Comparative |
|---|---|---|---|---|
| | ple 4 | ple 5 | Example 3 | Example 4 |
| Reference capacity | 2.65 | 2.68 | 2.62 | 2.71 |
| Discharge capacity | 2.64 | 2.65 | 2.28 | 2.23 |
| after leaving at high | | | | |
| temperature (mAh) | | | | |
| High-temperature | 99.5 | 98.9 | 87.1 | 82.2 |
| capacity retention | | | | |
| rate (%) | | | | |
| OCV (V) before leaving | 4.2 | 4.23 | 4.34 | 4.34 |
| at high temperature | | | | |
| OCV (V) after leaving | 4.08 | 4.10 | 4.15 | 4.13 |
| at high temperature | | | | |
| ΔV (V) | −0.12 | −0.13 | −0.19 | −0.21 |

Referring to Table 3 and FIGS. 5 and 6, when left at a high temperature of 90° C. for about 4 hours, the coin-type cells of Examples 4 and 5 had higher charge capacity than the coin-type cells of Comparative Examples 3 and 4. Thus, it was confirmed that the coin-type cells of Examples 4 and 5 have a higher high-temperature capacity retention rate than the coin-type cells of Comparative Examples 3 and 4. Also, it was confirmed that a secondary lithium battery according to an embodiment of the present invention has relatively good OCV characteristics after being left at the high temperature.

That is, the coin-type cells of Example 4 and Example 5 had an OCV drop of about 0.12 to about 0.13 V, the coin-type cell of Comparative Example 3 had an OCV drop of about 0.23 to about 0.24 V, which is double that of the coin-type cells of Example 4 and Example 5, and the coin-type cell of Comparative Example 4 had an OCV drop of about 0.18 to about 0.2 V. Also, the coin-type cells of Example 4 and Example 5 had a capacity retention rate of about 98 to about 100%, the coin-type cell of Comparative Example 3 had a capacity retention rate of about 82%, and the coin-type cell of Comparative Example 4 had a capacity retention rate of about 85˜89%.

An electrolyte solution for a secondary lithium battery according to embodiments of the present invention forms a thin polar SEI film on the surface of a cathode of a battery. Due to the formation of the thin polar film, decomposition and consumption of electrolyte solution components are prevented. Thus, the electrolyte solution provides excellent capacity retention characteristics at high voltage and excellent room-temperature lifetime characteristics to a secondary lithium battery. Also, it was confirmed that a secondary lithium battery including the electrolyte solution has excellent capacity retention characteristics even at high temperatures. Due to improved high-temperature lifetime characteristics, the electrolyte solution allows a battery to be driven under harsh conditions in a vehicle, and due to improved high-temperature preservation characteristics, the electrolyte solution is suitable for electric power storage that may be exposed to high temperatures. Also, the electrolyte solution may be suitable for use in a battery including a cathode active material to which high voltage may be applied, for example, a 5 V spinel, high-voltage phosphate cathode active material. Accordingly, it is expected that the electrolyte solution may contribute to an improvement in an energy density of batteries for electric vehicles and electric power storage.

As described above, according to the one or more of the above embodiments of the present invention, an electrolyte solution for a secondary lithium battery may form a thin film on the surface of a cathode so that lifetime characteristics of a battery including the electrolyte solution is improved. In addition, since the thin film has polarity, the electrolyte solution may enable production of a secondary lithium battery having high conductivity with respect to lithium ions.

It should be understood that the exemplary embodiments described herein should be considered in a descriptive sense only and not for purposes of limitation. Descriptions of features or aspects within each embodiment should typically be considered as available for other similar features or aspects in other embodiments.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electrolyte solution for a secondary lithium battery comprising:
a lithium salt;
a non-aqueous organic solvent; and
an additive, wherein the additive is a phenanthroline-based compound incorporating at least one polar substituent selected from the group consisting of an alkoxy group, an amine group, an ester group, a carbonate group, a carbonyl group, a keto group, an epoxy group, and an alkylthio group.

2. The electrolyte solution of claim 1, wherein the phenanthroline-based compound is 1,10-phenanthroline, 1,7-phenanthroline, or 4,7-phenanthroline.

3. The electrolyte solution of claim 1, wherein the additive is 4,7-dimethoxy-1,10-phenanthroline, 1,10-phenanthroline-5,6-dione, or 5,6-epoxy-5,6-dihydro-1,10-phenanthroline.

4. The electrolyte solution of claim 1, wherein the amount of the additive contained in the electrolyte solution is in a range of about 0.001 to about 5 weight %.

5. The electrolyte solution of claim 1, wherein the non-aqueous organic solvent comprises a carbonate-based solvent, an ester-based solvent, an ether-based solvent, a ketone-based solvent, an alcohol-based solvent, a non-protonic solvent, or a combination thereof.

6. A secondary lithium battery comprising:
a cathode;
an anode; and
an electrolyte solution,
wherein the electrolyte solution is the electrolyte solution of claim 1.

7. A secondary lithium battery comprising:
a cathode;
an anode; and
an electrolyte solution, wherein:
the electrolyte solution is the electrolyte solution of claim 1,
the cathode has a surface on which a thin film is formed, and
the thin film is derived from either a part of the additive or the entire additive.

8. The secondary lithium battery of claim 7, wherein the thickness of the film is in a range of about 1 nm to about 80 nm.

9. A secondary lithium battery comprising:
a cathode;
an anode; and
an electrolyte solution,
wherein the electrolyte solution comprises:
a lithium salt;
a non-aqueous organic solvent; and
an additive, wherein the additive is a phenanthroline-based compound incorporating at least one polar substituent.

10. The secondary lithium battery of claim 9, wherein the polar substituent is selected from the group consisting of an alkoxy group, an amine group, an ester group, a carbonate group, a carbonyl group, a keto group, an epoxy group, and an alkylthio group.

11. The secondary lithium battery of claim 9, wherein the cathode has a surface on which a thin film is formed, and the thin film is derived from either a part of the additive or the entire additive.

12. The secondary lithium battery of claim 11, wherein the thickness of the film is in a range of about 1 nm to about 80 nm.

13. The secondary lithium battery of claim 9, wherein the phenanthroline-based compound is 1,10-phenanthroline, 1,7-phenanthroline, or 4,7-phenanthroline.

14. The secondary lithium battery of claim 13, wherein the phenanthroline based compound is 4,7-dimethoxy-1,10-phenanthroline, 1,10-phenanthroline-5,6-dione, or 5,6-epoxy-5,6-dihydro-1,10-phenanthroline.

15. The secondary lithium battery of claim 9, wherein the amount of the additive contained in the electrolyte solution is in a range of about 0.001 to about 5 weight %.

16. An electrolyte solution for a secondary lithium battery comprising:
a lithium salt;
a non-aqueous organic solvent; and
a phenanthroline-based compound incorporating at least one polar substituent.

17. The electrolyte solution of claim 16, wherein the polar substituent is selected from the group consisting of an alkoxy group, an amine group, an ester group, a carbonate group, a carbonyl group, a keto group, an epoxy group, and an alkylthio group.

18. The electrolyte solution of claim 16, wherein the phenanthroline-based compound is 1,10-phenanthroline, 1,7-phenanthroline, or 4,7-phenanthroline.

19. The electrolyte solution of claim 18, wherein the phenanthroline-based compound is 4,7-dimethoxy-1,10-phenanthroline, 1,10-phenanthroline-5,6-dione, or 5,6-epoxy-5,6-dihydro-1,10-phenanthroline.

20. The electrolyte solution of claim 16, wherein the amount of the phenanthroline-based compound contained in the electrolyte solution is in a range of about 0.001 to about 5 weight %.
